(19) United States
(12) Patent Application Publication
(10) Pub. No.: US 2003/0092482 A1
(43) Pub. Date: May 15, 2003

(54) Gaming machine

(76) Inventor: Jason Meyer, Abbotsford (AU)

Correspondence Address: PILLSBURY WINTHROP, LLP, P.O. BOX 10500, MCLEAN, VA, 22102, US

(21) Appl. No.: 10/292,920

(22) Filed: Nov. 13, 2002

(30) Foreign Application Priority Data
Nov. 13, 2001 (AU) PR8841

(51) Int. Cl. G07F 17/34

(52) U.S. Cl. 463/20

(57) ABSTRACT

A gaming machine 1 with a player control console 3 and a display 2 for presenting a base game of chance wherein upon a trigger event the display 2 operates a feature which is selected from a range of features using player input controls 4 on the console 3.

### FIELD OF THE INVENTION

The present invention relates to gaming machines. The invention has been developed primarily for computerised gaming machines and will be described herein by reference to that application. However, the invention is not limited to that particular field of use and may be suitable for other applications such as gaming facilitated by the Internet.

### BACKGROUND OF THE INVENTION

Gaming machines have long been known, and are now one of the most common forms of gambling. One of the oldest and best known forms of gaming machine is the rotating reel type “poker machine”. Traditionally, poker machines use a series of three, four or five reels, each reel having symbols on its peripheral edge. The reels are rotated upon the placement of a bet and then stopped to produce an array of randomly selected symbols. Winnings are paid if the random selection of symbols matches one of the predetermined winning combinations.

Gaming machines can “pay winnings” in a variety of ways. These include dispensing money, dispensing tokens that can be redeemed for money, or simply adding credits to a credit meter that can be used for placing future bets or redeemed as money. More recently these gaming machines have been computerised and these machines now dominate the industry. Computerised machines usually award winnings in the form of credits tallied on a credit meter. In light of their widespread use, the present invention will be described in the context of this type of winnings payment mechanism. However, those skilled in the art will readily understand that the term encompasses other payment mechanisms.

Computerised gaming machines use a video screen to display a simulation of physically rotating reels. The display screen typically presents an array of symbols in five columns and three rows equating to the symbols that would normally be seen on the five physically rotating reels of an old style mechanical machine. Computerised machines have allowed players to simultaneously bet on the combination of symbols appearing in many different parts of the array. These parts of the array are often referred to as “paylines” consisting of lines of adjacent symbols extending through the array. The symbols may be laterally adjacent each other or diagonally adjacent each other. They usually extend along each row as well as various angled or “zig zag” lines through the array. Multiple paylines provide a more interesting and exciting game than the old style mechanical machines which traditionally offered a single payline only.

Players expect multiple paylines to be standard on spinning reel type gaming machines and the vast majority offer at least five paylines. In an ongoing effort to maintain the players interest, many machines now offer secondary or “feature” games. The feature appears upon some trigger event such as a predetermined outcome in the primary or “base” game and may be used to award the player with a relatively large win or benefit. Therefore, the feature can be a key factor in a player's choice of gaming machine. However, different players will tend to favour different features. Accordingly, gaming machine features can have a fairly narrow appeal, which in turn can restrict or limit the appeal of the game as a whole.

### SUMMARY OF THE INVENTION

It is an object of the present invention to overcome or ameliorate at least one of the disadvantages of the prior art, or to provide a useful alternative.

According to a first aspect, the present invention provides a gaming machine including:

a player control console and a display for presenting a base game of chance such that upon a trigger event, the display presents a feature selected from a range of available features via player input controls on the console.

According to a second aspect, the present invention provides a method of operating a gaming machine having a player control console and a display, including the steps of:

presenting a base game of chance, the base game of chance capable of producing a predetermined trigger event;

the display presenting a feature in response to an occurrence of the trigger event, wherein

the feature is selected from a range of available features via player input controls on the console.

Preferably, the base game has an array of randomly arranged symbols, the array having paylines that consist of unique combinations of sites within the array such that winnings are paid when predetermined winning combinations of symbols appear in any of the paylines carrying a bet; wherein,

the player input controls include feature selection buttons adapted to allow the simultaneous selection of:

a) the feature that occurs in response to a trigger event; and,

b) the number of paylines that will carry a bet.

In a further preferred form, the feature selection buttons ensure that two or more paylines are selected to carry a bet. Preferably, the player input controls also include bet selection buttons for separately selecting the amount bet per payline.

In other preferred embodiments, all the feature selection buttons cause a predetermined fixed number of paylines to carry a bet wherein the bet per payline is chosen with the bet selection buttons.

According to a third aspect, the present invention provides a gaming machine including:

a display for presenting an array of randomly arranged symbols, the array having paylines that consist of unique combinations of sites within the array, such that winnings are paid when predetermined winning combinations of symbols appear in any of the paylines carrying a bet; and,

a player control console for selecting a minimum of two paylines to carry a bet.

According to a fourth aspect, the present invention provides a method of operating a gaming machine having a display and a player control console, the method including the steps of:

presenting an array of randomly arranged symbols on the display, the array having paylines that consist of unique combinations of sites within the array for:

paying winnings in response to predetermined winning combinations of the symbols in any of the paylines carrying a bet; and

configuring the player control console such that a minimum of two paylines carry a bet.

According to a fifth aspect, the present invention provides a gaming machine including:

a display for presenting an array of randomly arranged symbols, the array having paylines that consist of unique combinations of sites within the array, such that winnings are paid when predetermined winning combinations of symbols appear in any of the paylines carrying a bet; and

a player control console adapted to always select a predetermined fixed number of paylines to carry a bet.

According to another aspect, the present invention provides a method of operating a gaming machine with a display and a player control console, the method including the steps of:

presenting an array of randomly arranged symbols on the display, the array having paylines that consist of unique combinations of sites within the array;

paying winnings in response to predetermined winning combinations of the symbols in any of the paylines carrying a bet; and

adapting the player control console to always select a predetermined fixed number of paylines to carry a bet.

Using the present invention, a gaming machine can broaden it's appeal to players by giving them the opportunity to select the feature from a range of different features. By configuring the machine so that selecting a feature automatically sets the number of paylines on which the player must bet allows the game designer to enforce a minimum number of paylines being played. This of course influences the profit returned by the machine, as well as exposing the player to games operating on a set number of paylines that may be greater than the number of paylines they traditionally select.

It will be appreciated that the present invention also permits gaming machines designed so that the player must select one of the features from those available, and each and every feature selection button automatically sets the number of paylines. This type of machine does not allow the player to select a single payline and gives the game designer the opportunity to raise the minimum expected return from an existing game with a simple reconfiguration of the minimum allowable number of paylines. Furthermore, the present invention also allows a gaming machine to be designed so that the number of paylines carrying a bet is no longer at the discretion of the player. This is done by removing any facility for varying the number of paylines, so that when the player selects the desired feature the game will operate on the basis of a preset number of paylines. The player remains in control of their expenditure using the bet selection button, however the player becomes accustomed to a higher level of screen activity.

### BRIEF DESCRIPTION OF THE DRAWINGS

A preferred embodiment of the invention will now be described, by way of example only, with reference to the accompanying drawings in which:

FIG. 1 is a perspective of the gaming machine; and,

FIG. 2 shows an enlarged portion of the console of the gaming machine shown in FIG. 1.

### DETAILED DESCRIPTION OF THE PREFERRED EMBODIMENTS

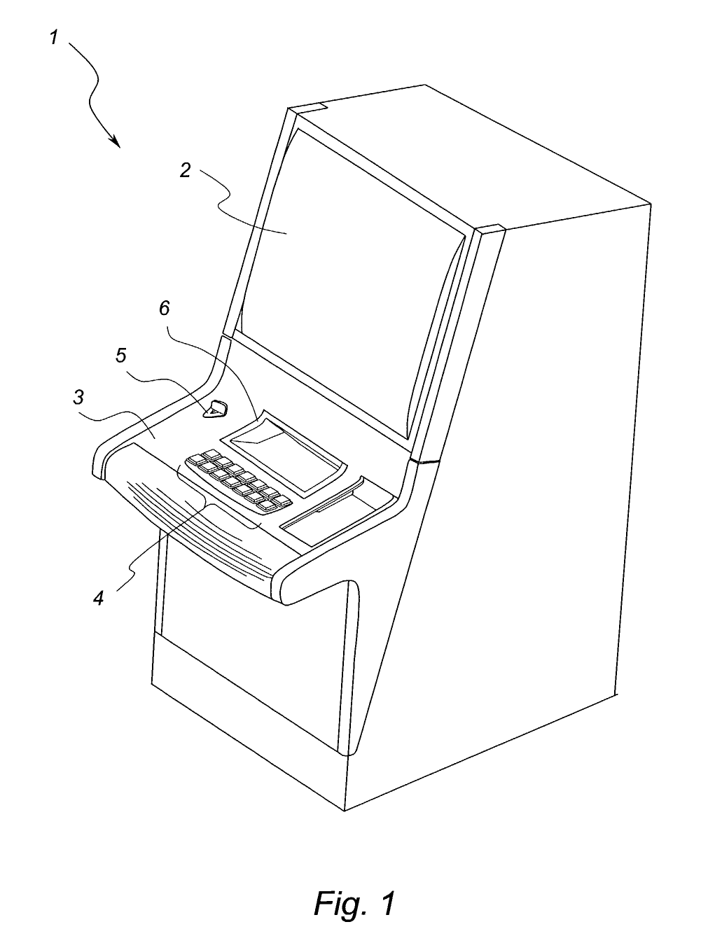

Referring to FIG. 1, the gaming machine 1 has a video display screen 2 and control console 3. The control console 3 includes coin slot 5 for inserting coins or tokens, a bank note slot 19, and a coin collection tray 6 for redeeming any winnings or unused coins or tokens. The console 3 also includes control buttons 4 for the player to select the feature they would prefer should a trigger occur, and, the number of credits they wish to bet on each payline. The machine automatically bets on 25 paylines regardless of the feature chosen. Of course, in other embodiments, different features can activate different numbers of paylines.

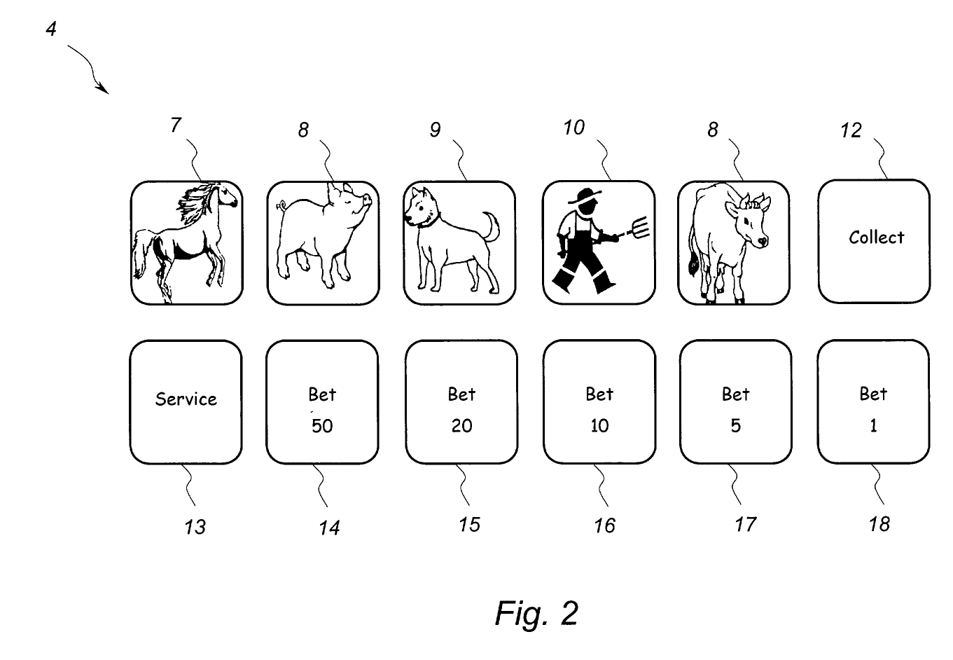

Referring to FIG. 2, some of the player operable buttons in the button panel 4 are shown. The collection button 12 is for dispensing unused coins or tokens into the collection tray 6 shown in FIG. 1 and the service button 18 is used to notify the venue proprietor of any faults. The player selects the number of credits per payline using buttons 13, 14, 15, 16 and 17 respectively. Buttons 7, 8, 9, 10 or 11 simultaneously select 25 paylines to carry a bet as well as designate the type of feature that will occur should the subsequent reel “spin” produces a trigger. The feature may be any type of benefit that awards, or has the potential to award, the player with relatively large wins. Some of the more common features include:

bonus credits that are simply added to credit meter;

free games where the reels spin without first requiring the player to place a bet so that any winning combinations in paylines that carried a bet immediately prior to the trigger will pay winnings that are added to the credit meter;

a win multiplier where the winnings from the base game reel spin that produced the trigger are multiplied by a factor and the resulting product is added to the credit meter;

a random win multiplier where the multiplying factor is randomly selected by the machine;

one or more held reels where the held reels remain fixed while the rest of the reels spin again. If the held reel is one with ‘high value’ symbols or wild card symbols, it is advantageous for the player to keep these in the array while the other reels spin to reproduce the remainder of the array. The machine may allow the player to nominate the reels to be held or the machine can randomly select the held reels; or,

any combinations of the above.

The horse button 7 may designate the feature of twenty free games with a random win multiplier. The pig button 8 may designate a simple bonus credit prize while the dog button 9 provides one free game. The farmer button 10 could designate a win multiplier while the cow button 11 will randomly select a reel to hold and respin the remaining reels.

Regardless of which of the feature buttons 7, 8, 9, 10 or 11 are chosen, simply using these buttons automatically selects 25 paylines to carry a bet. Then to initiate the reel spin the player simply has to chose the number of credits bet per line using buttons 12, 13, 19 or 20.

If some of the features designated by the feature buttons 7, 8, 9, 10 or 11, are more generous than others, then the machine can be configured so that only certain triggers will initiate the more generous features. In this way the game designer can set the frequency with which each of the triggers occur so that the more generous features do not appear too often.

The present invention conveniently allows the game designer to remove any option for the player to play a single payline only. This will at least increase the base or minimum level of screen activity during a game. The player is given the opportunity to control their expenditure by selecting the number of credits bet per payline.

It will be appreciated that the present invention also conveniently facilitates a game where the player has no choice in the number of paylines played. This is done using the present invention by assigning each feature the same number of paylines. In essence, this effectively substitutes the players ability to select different numbers of paylines for the ability to select different features. This aspect of the invention allows the game designer to enforce a much higher level of screen activity, as well as raising the minimum number of credits bet per spin of the reels. Of course, over time this translates into a greater return from the machine.

The present invention has been described herein by way of example only. Ordinary workers in this field will readily recognise many variations and modifications which do not depart from the spirit and scope of the broad inventive concept.

We claim:

1. A gaming machine including:
a player control console and a display for presenting a base game of chance such that upon a trigger event, the display presents a feature selected from a range of available features via player input controls on the console.

2. A gaming machine according to claim 1, wherein the base game has an array of randomly arranged symbols, the array having paylines that consist of unique combinations of sites within the array such that winnings are paid when predetermined winning combinations of symbols appear in any of the paylines carrying a bet; wherein,
the player input controls include feature selection buttons adapted to allow the simultaneous selection of:
a) the feature that occurs in response to a trigger event; and,
b) the number of paylines that will carry a bet.

3. A gaming machine according to claim 2, wherein the feature selection buttons ensure that two or more paylines are selected to carry a bet.

4. A gaming machine according to claim 3, wherein the player input controls also include bet selection buttons for separately selecting the amount bet per payline.

5. A gaming machine according to claim 4, wherein all the feature selection buttons cause a predetermined fixed number of paylines to carry a bet wherein the bet per payline is chosen with the bet selection buttons.

6. A method of operating a gaming machine having a player control console and a display, including the steps of:
presenting a base game of chance, the base game of chance capable of producing a predetermined trigger event;
the display presenting a feature in response to an occurrence of the trigger event, wherein
the feature is selected from a range of available features via player input controls on the console.

7. A method of operating a gaming according to claim 6, wherein the base game has an array of randomly arranged symbols, the array having paylines that consist of unique combinations of sites within the array such that winnings are paid when predetermined winning combinations of symbols appear in any of the paylines carrying a bet; wherein,
the player input controls include feature selection buttons adapted to allow the simultaneous selection of:
c) the feature that occurs in response to a trigger event; and,
d) the number of paylines that will carry a bet.

8. A method of operating a gaming according to claim 7, wherein the feature selection buttons ensure that two or more paylines are selected to carry a bet.

9. A method of operating a gaming according to claim 8, wherein the player input controls also include bet selection buttons for separately selecting the amount bet per payline.

10. A method of operating a gaming according to claim 9, wherein all the feature selection buttons cause a predetermined fixed number of paylines to carry a bet wherein the bet per payline is chosen with the bet selection buttons.

11. A gaming machine including:
a display for presenting an array of randomly arranged symbols, the array having paylines that consist of unique combinations of sites within the array, such that winnings are paid when predetermined winning combinations of symbols appear in any of the paylines carrying a bet; and,
a player control console for selecting a minimum of two paylines to carry a bet.

12. A method of operating a gaming machine having a display and a player control console, the method including the steps of:
presenting an array of randomly arranged symbols on the display, the array having paylines that consist of unique combinations of sites within the array;
paying winnings in response to predetermined winning combinations of the symbols in any of the paylines carrying a bet; and
configuring the player control console such that a minimum of two paylines carry a bet.

13. A gaming machine including:
a display for presenting an array of randomly arranged symbols, the array having paylines that consist of unique combinations of sites within the array, such that winnings are paid when predetermined winning combinations of symbols appear in any of the paylines carrying a bet; and
a player control console adapted to always select a predetermined fixed number of paylines to carry a bet.

14. A method of operating a gaming machine with a display and a player control console, the method including the steps of:
presenting an array of randomly arranged symbols on the display, the array having paylines that consist of unique combinations of sites within the array;
paying winnings in response to predetermined winning combinations of the symbols in any of the paylines carrying a bet; and
adapting the player control console to always select a predetermined fixed number of paylines to carry a bet.
